(19) United States
(12) Patent Application Publication
(10) Pub. No.: US 2002/0070692 A1
(43) Pub. Date: Jun. 13, 2002

(54) ELECTROMAGNETIC AUTOMOTIVE MOTOR SYSTEM

(76) Inventor: Nestor Gonzales, Miami, FL (US)

Correspondence Address: Ivar M. Kaardal, Kaardal & Asscoiates, PC, 3500 South First Ave. Circle - Suite 250, Sioux Falls, SD, 57105-5802, US

(21) Appl. No.: 09/735,355

(22) Filed: Dec. 12, 2000

(51) Int. Cl. H02P 1/54

(52) U.S. Cl. 318/34

(57) ABSTRACT

An electromagnetic automotive motor system for providing energy efficient automotive drive capabilities with minimal pollution. The electromagnetic automotive motor system includes a modular engine system for converting electrical current into rotational kinetic energy, a battery storage system electrically coupled to the modular engine system used for providing electrical current to said modular engine system and a drive train output system mechanically coupled to the modular engine system adapted for transferring rotation from the modular engine system to a drive shaft of an automotive vehicle.

### BACKGROUND OF THE INVENTION

1. Field of the Invention

The present invention relates to electromagnetic motors and more particularly pertains to a new electromagnetic automotive motor system for providing energy efficient automotive drive capabilities with minimal pollution.

2. Description of the Prior Art

The use of electromagnetic motors is known in the prior art. More specifically, electromagnetic motors heretofore devised and utilized are known to consist basically of familiar, expected and obvious structural configurations notwithstanding the myriad of designs encompassed by the crowded prior art which have been developed for the fulfillment of countless objectives and requirements.

Known prior art includes U.S. Pat. No. 4,554,989; U.S. Pat. No. 5,680,908; U.S. Pat. No. 4,208,620; U.S. Pat. No. 5,036,930; U.S. Pat. No. 4,218,624; U.S. Pat. No. 3,861,487; U.S. Pat. No. Des. 297,426; and U.S. Pat. No. 4,216,839.

While these devices fulfill their respective, particular objectives and requirements, the aforementioned patents do not disclose a new electromagnetic automotive motor system. The inventive device includes a modular engine system for converting electrical current into rotational kinetic energy, a battery storage system electrically coupled to the modular engine system used for providing electrical current to said modular engine system and a drive train output system mechanically coupled to the modular engine system adapted for transferring rotation from the modular engine system to a drive shaft of an automotive vehicle.

In these respects, the electromagnetic automotive motor system according to the present invention substantially departs from the conventional concepts and designs of the prior art, and in so doing provides an apparatus primarily developed for the purpose of providing energy efficient automotive drive capabilities with minimal pollution.

### SUMMARY OF THE INVENTION

In view of the foregoing disadvantages inherent in the known types of electromagnetic motors now present in the prior art, the present invention provides a new electromagnetic automotive motor system construction wherein the same can be utilized for providing energy efficient automotive drive capabilities with minimal pollution.

The general purpose of the present invention, which will be described subsequently in greater detail, is to provide a new electromagnetic automotive motor system apparatus and method which has many of the advantages of the electromagnetic motors mentioned heretofore and many novel features that result in a new electromagnetic automotive motor system which is not anticipated, rendered obvious, suggested, or even implied by any of the prior art electromagnetic motors, either alone or in any combination thereof.

To attain this, the present invention generally comprises a modular engine system for converting electrical current into rotational kinetic energy, a battery storage system electrically coupled to the modular engine system used for providing electrical current to said modular engine system and a drive train output system mechanically coupled to the modular engine system adapted for transferring rotation from the modular engine system to a drive shaft of an automotive vehicle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new electromagnetic automotive motor system apparatus and method which has many of the advantages of the electromagnetic motors mentioned heretofore and many novel features that result in a new electromagnetic automotive motor system which is not anticipated, rendered obvious, suggested, or even implied by any of the prior art electromagnetic motors, either alone or in any combination thereof.

It is another object of the present invention to provide a new electromagnetic automotive motor system which may be easily and efficiently manufactured and marketed.

It is a further object of the present invention to provide a new electromagnetic automotive motor system which is of a durable and reliable construction.

An even further object of the present invention is to provide a new electromagnetic automotive motor system which is susceptible of a low cost of manufacture with regard to both materials and labor, and which accordingly is then susceptible of low prices of sale to the consuming public, thereby making such electromagnetic automotive motor system economically available to the buying public.

Still yet another object of the present invention is to provide a new electromagnetic automotive motor system which provides in the apparatuses and methods of the prior art some of the advantages thereof, while simultaneously overcoming some of the disadvantages normally associated therewith.

Still another object of the present invention is to provide a new electromagnetic automotive motor system for providing energy efficient automotive drive capabilities with minimal pollution.

Yet another object of the present invention is to provide a new electromagnetic automotive motor system which includes a modular engine system for converting electrical current into rotational kinetic energy, a battery storage system electrically coupled to the modular engine system used for providing electrical current to said modular engine system and a drive train output system mechanically coupled to the modular engine system adapted for transferring rotation from the modular engine system to a drive shaft of an automotive vehicle.

Still yet another object of the present invention is to provide a new electromagnetic automotive motor system that produces minimal pollution during operation.

Even still another object of the present invention is to provide a new electromagnetic automotive motor system that is modular and adaptable for various power and torque requirements.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic block diagram view of a new electromagnetic automotive motor system according to the present invention.

FIG. 2 is a schematic bottom view of an embodiment of the present invention.

FIG. 3 is a schematic cross-sectional view of the electric motor in an embodiment of the present invention.

### DESCRIPTION OF THE PREFERRED EMBODIMENT

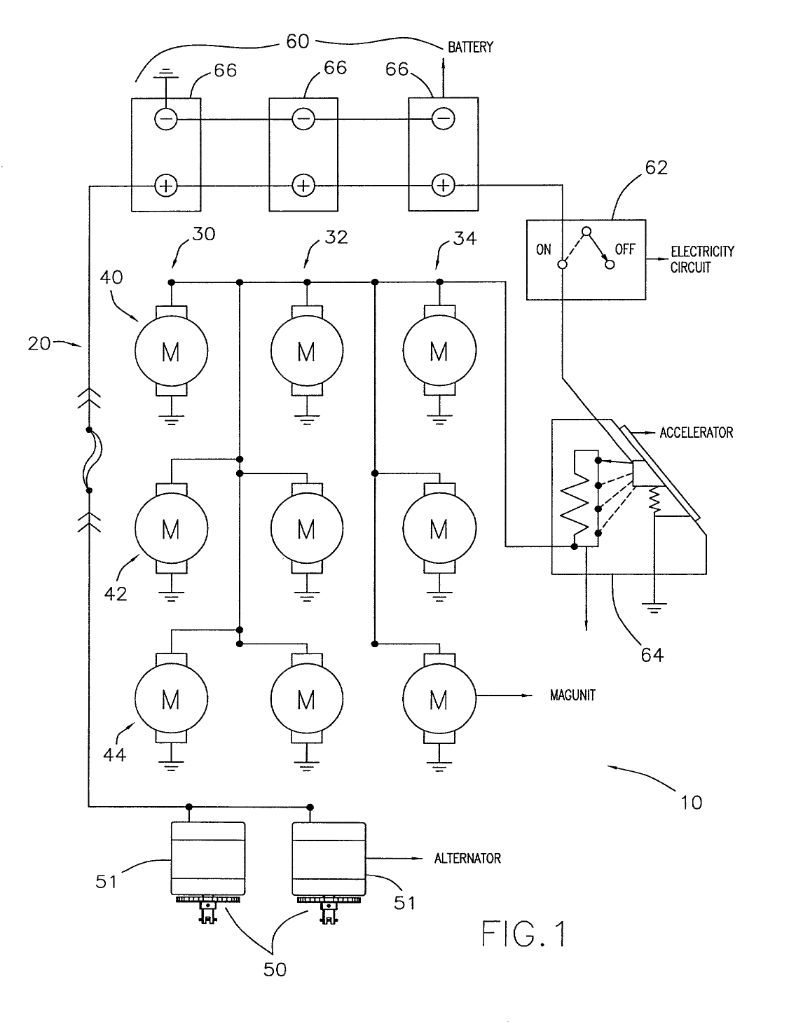

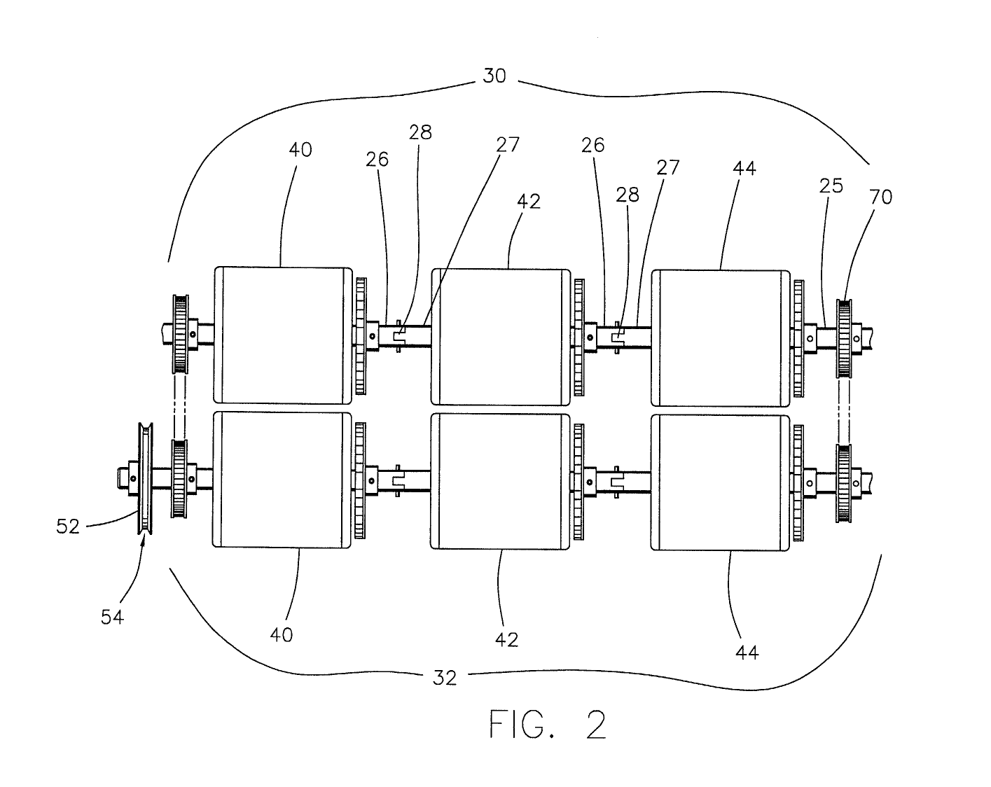

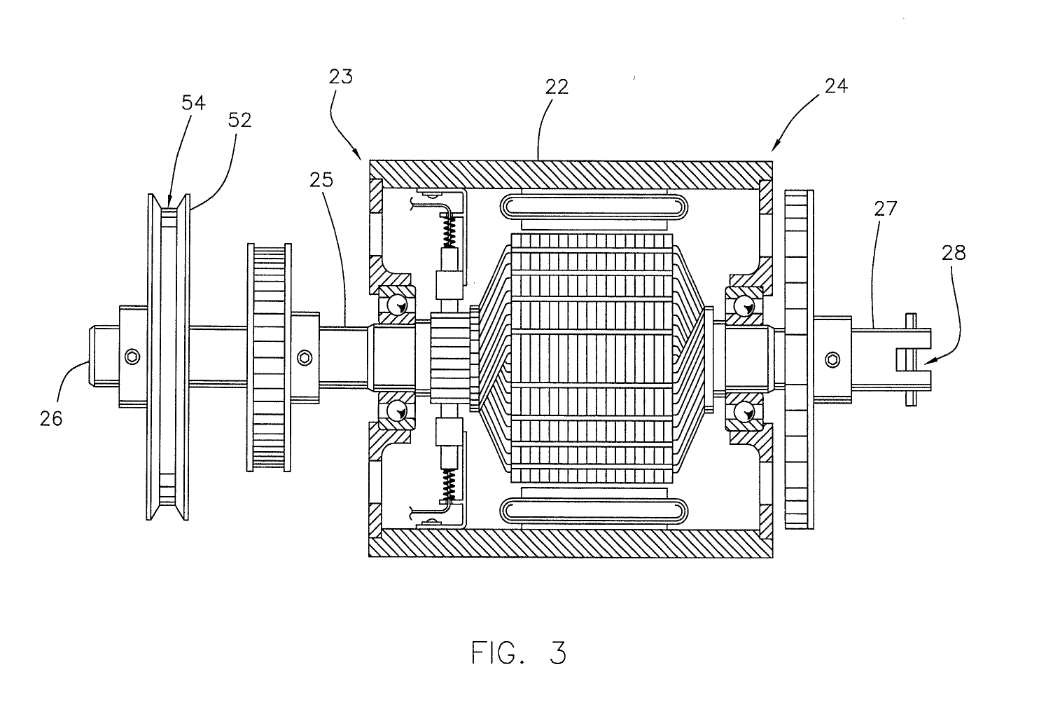

With reference now to the drawings, and in particular to FIGS. 1 through 3 thereof, a new electromagnetic automotive motor system embodying the principles and concepts of the present invention and generally designated by the reference numeral 10 will be described.

As best illustrated in FIGS. 1 through 3, the electromagnetic automotive motor system 10 generally comprises a modular engine system 20, a battery storage system 60, and a drive train output system 70. The modular engine system 20 is used for converting electrical current into rotational kinetic energy.

The battery storage system 60 is electrically coupled to the modular engine system 20. The battery storage system 60 provides electrical current to the modular engine system 20. The battery storage system 60 comprises three storage batteries 66 electrically coupled in parallel.

The drive train output system 70 is mechanically coupled to the modular engine system 20 for transferring rotation from the modular engine system 20 to a drive shaft of an automotive vehicle.

An electrical alternator system 50 is mechanically coupled to the modular engine system 20. The electrical alternator system 50 converts rotational kinetic energy into electrical current. The electrical alternator system 50 comprises two alternators 51 each rotationally coupled in parallel with modular engine system 20, each one of the alternators 51 is electrically coupled to the battery storage system 60 in parallel.

A switch 62 is electrically coupled between the battery storage system 60 and the modular engine system 20. The switch 62 has an open position such that current does not flow between the battery storage system 60 and the modular engine system 20 when the switch 62 is in the open position. The switch 62 has a closed position such that current does flow between the battery storage system 60 and the modular engine system 20 when the switch 62 is in the closed position.

An electronic accelerator member 64 has a continuum of setting ranging from 0 to 100%. The electronic accelerator member 64 is electrically coupled between the switch 62 and the modular engine system 20 such that the amount of current available and flowing from the battery storage system 60 to the modular engine system 20 is controllable between the range of 0 and 100% by the electronic accelerator member 64.

The modular engine system 20 comprises an array of nine electric motors. The array comprises a first bank 30 of three electric motors 22 coupled in series, a second bank 32 of three electric motors 22 coupled in series, and a third bank 34 of three electric motors 22 coupled in series. The first 30, second 32, and third banks 34 of electric motors 22 are coupled in parallel.

Each one of the array of nine electric motors includes a shaft 25 with a first end 26, which extends from a first end 23 of the electric motor 22. The shaft 25 is positioned along a longitudinal axis of the electric motor 22. The shaft 25 provides rotational kinetic energy from the electric motor 22.

Each one of the shafts 25 includes a second end 27, which extends from a second end 24 of the electric motor 22. The second end 27 includes a slot 28, which is positioned perpendicularly to the longitudinal axis.

Each one of the banks 30,32,34 of electric motors 22 comprises a first electric motor 40, a second electric motor 42, and a third electric motor 44. The first electric motor 40 includes a shaft 25, which extends through a first end 23 and a second end 24. The second electric motor 42 includes a shaft 25, which extends through a first end 23 and a second end 24. The shaft 25 of the second electric motor 42 includes a first end 26 coupled to a second end 27 of the shaft 25 of the first electric motor 40. The third electric motor 44 also includes a shaft 25, which extends through a first end 23 and a second end 24. The shaft 25 of the third electric motor 44 includes as first end 26 coupled to a second end 27 of the shaft 25 of the second electric motor 42. The first 40, second 42, and third electric motors 44 are coupled in series to provide substantially more torque than a single electric motor. Each of the first 40, second 42, and third electric motors 44 are of substantially identical configuration.

Each one of said first 30, second 32, and third banks of electric motors 34 further comprise a pulley 52 coupled to the first end 26 of the shaft 25 of the first electric motor 40. The pulley 52 has an annular groove 54, which extends around a perimeter of the pulley 52.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electromagnetic automotive motor system comprising:
a modular engine system for converting electrical current into rotational kinetic energy;
a battery storage system electrically coupled to said modular engine system, said battery storage system providing electrical current to said modular engine system;
a drive train output system mechanically coupled to said modular engine system being for transferring rotation from said modular engine system to a drive shaft of an automotive vehicle.

2. The electromagnetic automotive motor system of claim 1, further comprising:
an electrical alternator system mechanically coupled to said modular engine system, said electrical alternator system converting rotational kinetic energy into electrical current.

3. The electrical automotive motor system of claim 2, wherein said electrical alternator system comprises two alternators each rotationally coupled in parallel with said array of electric motors, each one of said alternators being electrically coupled to said battery storage system in parallel.

4. The electrical automotive motor system of claim 2, wherein said battery storage system comprising three storage batteries electrically coupled in parallel.

5. The electrical automotive motor system of claim 2, further comprising:
a switch electrically coupled between said battery storage system and said modular engine system, said switch having an open position such that current does not flow between said battery storage system and said modular engine system when said switch is in the open position, said switch having a closed position such that current does flow between said battery storage system and said modular engine system when said switch is in the closed position.

6. The electrical automotive motor system of claim 5, further comprising:
an electronic accelerator member having a continuum of setting ranging from 0 to 100%, said electronic accelerator member being electrically coupled between said switch and said modular engine system such that the amount of current available and flowing from said battery storage system to said modular engine system is controllable between the range of 0 and 100% by said electronic accelerator member.

7. The electromagnetic automotive motor system of claim 1, wherein said modular engine system comprises:
an electric motor having a shaft having a first end extending from a first end of said electric motor, said shaft being positioned along a longitudinal axis of said electric motor, said shaft providing rotational kinetic energy from said electric motor.

8. The electromagnetic automotive motor system of claim 7, wherein said shaft having a second end extending from a second end of said electric motor, said second end having a slot positioned perpendicularly to said longitudinal axis.

9. The electromagnetic automotive motor system of claim 7, wherein said modular engine system further comprises a pulley coupled to said first end of said shaft, said pulley having an annular groove extending around a perimeter of said pulley.

10. The electromagnetic automotive motor system of claim 7, further comprising:
said shaft having a second end extending from a second end of said electric motor, said second end having a slot positioned perpendicularly to said longitudinal axis;
a pulley coupled to said first end of said shaft, said pulley having an annular groove extending around a perimeter of said pulley.

11. The electromagnetic automotive system of claim 10, wherein said modular engine system comprises a first electric motor, a second electric motor, and a third electric motor, said first electric motor having a shaft extending through a first end and a second end, said second electric motor having a shaft extending through a first end and a second end, said shaft of said second electric motor having a first end coupled to a second end of said shaft of said first electric motor, said third electric motor having a shaft extending through a first end and a second end, said shaft of said third electric motor having as first end coupled to a second end of said shaft of said second electric motor, said first, second, and third electric motors being coupled in series to provide substantially more torque than a single electric motor.

12. The electromagnetic automotive system of claim 10, wherein said modular engine system comprises a first electric motor, a second electric motor, and a third electric motor, said first, second, and third electric motors being mechanically coupled in parallel to provide substantially more power than a single electric motor.

13. The electromagnetic automotive system of claim 10, wherein said modular engine system comprises an array of nine electric motors, said array comprising a first bank of three electric motors coupled in series, a second bank of three electric motors coupled in series, and a third bank of three electric motors coupled in series.

14. An electromagnetic automotive motor system comprising:
a modular engine system for converting electrical current into rotational kinetic energy;
a battery storage system electrically coupled to said modular engine system, said battery storage system providing electrical current to said modular engine system;
a drive train output system mechanically coupled to said modular engine system being for transferring rotation from said modular engine system to a drive shaft of an automotive vehicle;
an electrical alternator system mechanically coupled to said modular engine system, said electrical alternator system converting rotational kinetic energy into electrical current;
a switch electrically coupled between said battery storage system and said modular engine system, said switch having an open position such that current does not flow between said battery storage system and said modular engine system when said switch is in the open position, said switch having a closed position such that current does flow between said battery storage system and said modular engine system when said switch is in the closed position;
an electronic accelerator member having a continuum of setting ranging from 0 to 100%, said electronic accelerator member being electrically coupled between said switch and said modular engine system such that the amount of current available and flowing from said battery storage system to said modular engine system is controllable between the range of 0 and 100% by said electronic accelerator member; and
said modular engine system comprising:
an electric motor having a shaft having a first end extending from a first end of said electric motor, said shaft being positioned along a longitudinal axis of said electric motor, said shaft providing rotational kinetic energy from said electric motor;
said shaft having a second end extending from a second end of said electric motor, said second end having a slot positioned perpendicularly to said longitudinal axis;
a pulley coupled to said first end of said shaft, said pulley having an annular groove extending around a perimeter of said pulley.

15. An electromagnetic automotive motor system comprising:
a modular engine system for converting electrical current into rotational kinetic energy;
a battery storage system electrically coupled to said modular engine system, said battery storage system providing electrical current to said modular engine system;
a drive train output system mechanically coupled to said modular engine system being for transferring rotation from said modular engine system to a drive shaft of an automotive vehicle;
an electrical alternator system mechanically coupled to said modular engine system, said electrical alternator system converting rotational kinetic energy into electrical current;
a switch electrically coupled between said battery storage system and said modular engine system, said switch having an open position such that current does not flow between said battery storage system and said modular engine system when said switch is in the open position, said switch having a closed position such that current does flow between said battery storage system and said modular engine system when said switch is in the closed position;
an electronic accelerator member having a continuum of setting ranging from 0 to 100%, said electronic accelerator member being electrically coupled between said switch and said modular engine system such that the amount of current available and flowing from said battery storage system to said modular engine system is controllable between the range of 0 and 100% by said electronic accelerator member;
said modular engine system comprising an array of nine electric motors, said array comprising a first bank of three electric motors coupled in series, a second bank of three electric motors coupled in series, and a third bank of three electric motors coupled in series;
each one of said array of nine electric motors having a shaft having a first end extending from a first end of said electric motor, said shaft being positioned along a longitudinal axis of said electric motor, said shaft providing rotational kinetic energy from said electric motor;
each one of said shafts having a second end extending from a second end of said electric motor, said second end having a slot positioned perpendicularly to said longitudinal axis;
each one of said banks of electric motors comprising a first electric motor, a second electric motor, and a third electric motor, said first electric motor having a shaft extending through a first end and a second end, said second electric motor having a shaft extending through a first end and a second end, said shaft of said second electric motor having a first end coupled to a second end of said shaft of said first electric motor, said third electric motor having a shaft extending through a first end and a second end, said shaft of said third electric motor having as first end coupled to a second end of said shaft of said second electric motor, said first, second, and third electric motors being coupled in series to provide substantially more torque than a single electric motor;
said electric alternator system comprising two alternators each rotationally coupled in parallel with said array of electric motors, each one of said alternators being electrically coupled to said battery storage system in parallel; and
said battery storage system comprising three storage batteries electrically coupled in parallel.
